(19) United States
(12) Patent Application Publication
(10) Pub. No.: US 2006/0253273 A1
(43) Pub. Date: Nov. 9, 2006

(54) Information extraction using a trainable grammar

(76) Inventors: Ronen Feldman, Petach Tikva (IL); Benjamin Rosenfeld, St. Petersburg (RU); Yair Liberzon, Kiron (IL)

Correspondence Address: ABELMAN, FRAYNE & SCHWAB, 666 THIRD AVENUE, 10TH FLOOR, NEW YORK, NY, 10017, US

(21) Appl. No.: 11/269,475

(22) Filed: Nov. 7, 2005

Related U.S. Application Data
(60) Provisional application No. 60/626,282, filed on Nov. 8, 2004.

(51) Int. Cl. G06F 17/27

(52) U.S. Cl. 704/9

(57) ABSTRACT

A computer-implemented method for information extraction includes defining a stochastic context free grammar (SCFG) including symbols and rules applicable to the symbols, the symbols including at least one output concept. The SCFG is trained on a tagged training corpus so as to determine probabilities of the rules and of one or more of the symbols. A document is parsed using the rules and symbols responsively to the probabilities so as to extract occurrences of the at least one output concept from the document.

### CROSS-REFERENCE TO RELATED APPLICATION

This application claims the benefit of U.S. Provisional Patent Application 60/626,282, filed Nov. 8, 2004, which is incorporated herein by reference.

### FIELD OF THE INVENTION

The present invention relates generally to automated information extraction (IE), and specifically to methods and systems for extraction of information from corpora of unstructured documents.

### BACKGROUND OF THE INVENTION

IE applies natural language processing and information retrieval techniques to automatically extract essential details from text documents. IE systems that are known in the art generally adopt either knowledge-based or machine-learning approaches to extract specified information from large corpora of documents.

In knowledge-based systems, human beings with expertise in the relevant knowledge domain write rules, which are then applied by a computer to the documents in a corpus in order to extract the desired information. Such systems thus focus on manually writing patterns to extract particular entities and relations. The patterns are naturally accessible to human understanding, and can thus be improved in a controllable way.

In machine-learning methods, a domain expert labels the target concepts in a set of documents (referred to as the “training corpus”). The IE system then learns a model of the extraction task, which it can apply to new documents automatically. Some systems use a set of rules for this purpose. For example, Freitag describes a machine-learning approach based on grammar learning in “Using Grammatical Inference to Improve Precision in Information Extraction,” Workshop on Grammatical Inference, Automata Induction, and Language Acquisition (ICML '97) (Nashville, Tenn., 1997), which is incorporated herein by reference.

Other machine-learning methods use statistical representations, in which the IE system automatically constructs a probabilistic model based on the labeled training corpus. Once trained, the probabilistic model can estimate the probability that a given text fragment contains a target concept. Various probabilistic models have been used for this purpose. For example, Freitag and McCallum describe the use of Hidden Markov Models in an IE model in “Information Extraction with HMM Structures Learned by Stochastic Optimization,” Proceedings of the Seventeenth National Conference on Artificial Intelligence and Twelfth Conference on Innovative Applications of Artificial Intelligence (AAAI/IAAI 2000) (MIT Press, 2000), pages 584-589, which is incorporated herein by reference.

Stochastic context-free grammars (SCFGs) have also been used as probabilistic models in machine-learning-based IE systems. (Some authors refer to such grammars as probabilistic context-free grammars.) For example, Collins and Miller describe such a system for extraction of events at the sentence level in “Semantic Tagging using a Probabilistic Context Free Grammar,” Proceedings of the Sixth Workshop on Very Large Corpora (Montreal, Canada, 1998), which is incorporated herein by reference. The authors describe the application of the SCFG approach to a management succession task. The task in this case was to identify three slots involved in each succession event: the post, person coming into the post, and person leaving the post. The IE system used a part-of-speech tagger, a morphological analyzer, and a set of training examples that were manually labeled with the three slots and the indicator (verb or noun) used to express the event. To train the SCFG model, each training sentence is parsed into a tree structure according to the grammar. Event counts are extracted from the trees and are used in calculating estimated probabilities of context-free rules in relation to each type of event. The same grammar and rules are then applied to extract events from untagged documents.

### SUMMARY OF THE INVENTION

Embodiments of the present invention use a hybrid statistical and knowledge-based model to extract information from a corpus. This model benefits from the high accuracy level that characterizes knowledge-based systems in comparison with stochastic approaches. At the same time, the amount of work that human users must perform to prepare the model is generally much lower than in conventional knowledge-based systems, since the model makes use of statistics drawn from a training corpus.

In the embodiments disclosed hereinbelow, a human operator writes a set of IE rules for a domain of interest using a stochastic context-free grammar (SCFG). The grammar provides flexible classes of terminal symbols, which enable users to define grammars of arbitrary structure and to condition the probability of rules and symbols upon context. The probabilities of the rules and flexible terminal symbols are calculated automatically based on a tagged training corpus. The rules and probabilities may then be applied in extracting both entities and relationships from untagged documents, even when many or most of the sentences in the documents are not relevant to the target entities or relationships.

There is therefore provided, in accordance with an embodiment of the present invention, a computer-implemented method for information extraction, including:

defining a stochastic context free grammar (SCFG) including symbols and rules applicable to the symbols, the symbols including at least one output concept;

training the SCFG on a tagged training corpus so as to determine probabilities of the rules and of one or more of the symbols; and

parsing a document using the rules and symbols responsively to the probabilities so as to extract occurrences of the at least one output concept from the document.

In one aspect of the present invention, the symbols in the SCFG include a termlist symbol, which includes a collection of terms from a single semantic category.

In another aspect, the symbols in the SCFG include an ngram symbol, such that when the ngram symbol is used in one of the rules, it can expand to any single token. Typically, training the SCFG includes computing the probabilities of different expansions of the ngram symbol and may include computing the probabilities includes finding conditional probabilities of the different expansions depending upon a context of the ngram symbol. In a disclosed embodiment, computing the probabilities includes interpolating over a bigram probability model depending upon the context of the ngram symbol and a unigram probability model of the ngram symbol.

Additionally or alternatively, the ngram symbol includes an unknown symbol, and parsing the document includes applying the probabilities determined with respect to the unknown symbol in parsing an unknown token in the document.

In some embodiments, defining the SCFG includes defining a dependence of at least one of the rules on a context of a symbol to which the at least one of the rules is to apply, and training the SCFG includes finding a conditional probability of the at least one of the rules depending upon the context of the symbol.

In a disclosed embodiment, parsing the document includes applying an external feature generator in order to identify features of tokens in the document, and extracting the occurrences of the at least one output concept responsively to the features.

The method may also include, after parsing the document, enhancing the SCFG by performing at least one of adding a further rule to the SCFG and further tagged tokens to the training corpus.

There is also provided, in accordance with an embodiment of the present invention, a computer software product, including a computer-readable medium in which program instructions are stored, which instructions, when read by a computer, cause the computer to receive a definition of a stochastic context free grammar (SCFG) including symbols and rules applicable to the symbols, the symbols including at least one output concept, to train the SCFG on a tagged training corpus so as to determine probabilities of the rules and of one or more of the symbols, and to parse a document using the rules and symbols responsively to the probabilities so as to extract occurrences of the at least one output concept from the document.

There is additionally provided, in accordance with an embodiment of the present invention, apparatus for information extraction (IE), including:

an input interface, which is coupled to receive a definition of a stochastic context free grammar (SCFG) including symbols and rules applicable to the symbols, the symbols including at least one output concept; and

an IE processor, which is adapted to train the SCFG on a tagged training corpus so as to determine probabilities of the rules and of one or more of the symbols, and to parse a document using the rules and symbols responsively to the probabilities so as to extract occurrences of the at least one output concept from the document.

The present invention will be more fully understood from the following detailed description of the embodiments thereof, taken together with the drawings in which:

### BRIEF DESCRIPTION OF THE DRAWINGS

FIG. 1 is a schematic, pictorial illustration of an IE system, in accordance with an embodiment of the present invention;

FIG. 2 is a flow chart that schematically illustrates a method for IE using a SCFG, in accordance with an embodiment of the present invention; and

FIG. 3 is a flow chart that schematically illustrates a method for training a SCFG, in accordance with an embodiment of the present invention.

### DETAILED DESCRIPTION OF EMBODIMENTS

### System Overview

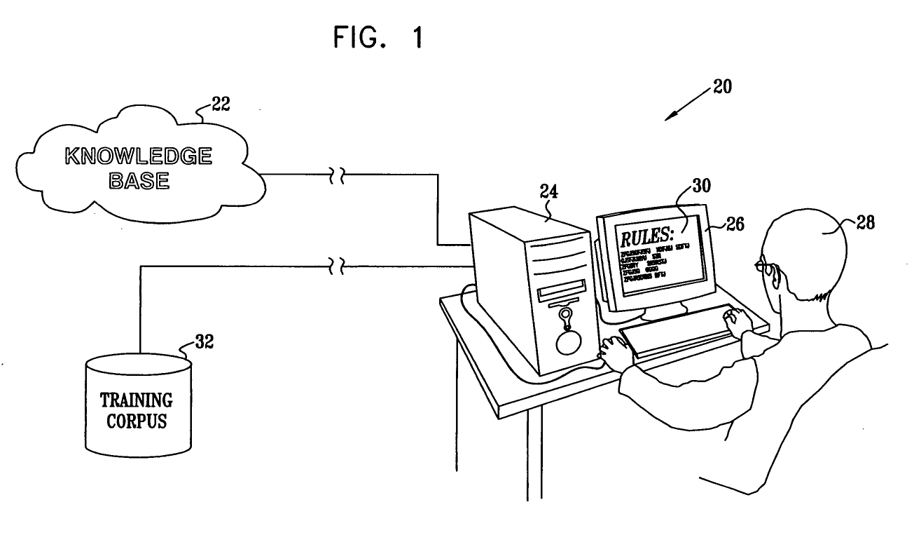

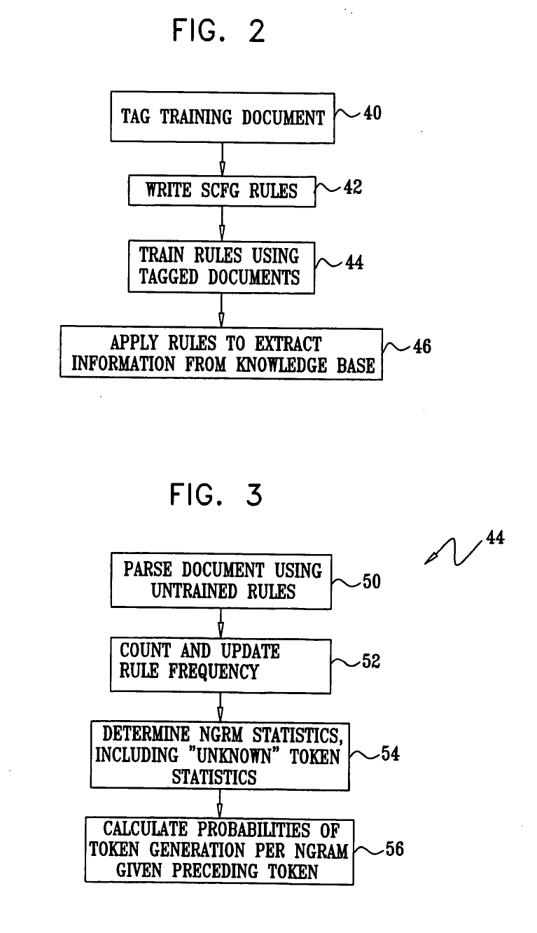

Reference is now made to FIGS. 1 and 2, which schematically illustrate, respectively, a system 20 and a method for IE, in accordance with an embodiment of the present invention. The system is typically used in extracting information about specified types of entities and relationships from a knowledge base 22, which may comprise one or more corpora of documents, typically unstructured documents written in natural language. More generally, the system may be used to extract such information from substantially any sort of document. System 20 comprises an IE processor 24, typically a general purpose computer, which is programmed in software to carry out the functions described hereinbelow. The software may be downloaded to processor 24 in electronic form, over a network, for example, or it may alternatively be furnished on tangible media, such as magnetic, optical or non-volatile electronic memory media.

System 20 uses a training corpus 32, which comprises a set of documents that have been tagged with predefined tokens, at tagging step 40. For example, if one of the tokens is “Person,” a sentence in the corpus might be tagged as follows:
Yesterday, <Person>Dr. Simmons</Person>, the distinguished scientist, presented the discovery.

Processor 24 is coupled to an input/output (I/O) interface 26, typically a user interface comprising a monitor, keyboard and pointing device, which enables a human user 28 to write a SCFG, including a set of rules 30, at a SCFG definition step 42. This same interface may be used in tagging the documents in training corpus 32. Additionally or alternatively, system 20 may use pre-tagged documents. Further additionally or alternatively, the I/O interface may comprise a communication interface (not shown) for receiving a definition of the SCFG and/or other software elements from an external source.

Processor 24 then applies the rules to training corpus 32 in order to determine the probabilities of the rules and symbols in the SCFG, at a training step 44. This step is described in greater detail hereinbelow with reference to FIG. 3. After the probability values have been determined on the training corpus, processor 24 applies the SCFG to extract information from documents in knowledge base 22, at an information extraction step 46. The processor outputs the results via interface 26.

After observing the results obtained at step 46, user 28 may improve the SCFG, typically by refining existing rules or adding new rules. Additionally or alternatively, further documents may be tagged and added to training corpus 32, and additional tags may be added to documents already in the corpus. The rules may then be retrained at step 44 and applied at step 46 to extract information with greater accuracy or including new concepts. To enhance accuracy, the user may choose and trade off between adding more detailed rules and adding tags (in new or existing documents) to the training corpus. In general, however, the combined rule-based and statistical approach allows system 20 to achieve high accuracy while using a relatively compact, simple grammar in comparison with pure knowledge-based systems, and a relatively small number of tagged training documents in comparison with pure machine learning-based systems that are known in the art.

### SCFG Formalism and Rules

A stochastic context-free grammar (SCFG) can be represented as a quintuple G=(T, N, S, R, P), wherein:
T is the alphabet of terminal symbols (tokens);
N is the set of nonterminals;
S is the starting nonterminal;
R is the set of rules; and
P:R→[0 . . . 1] defines the probabilities of the rules.
   The rules have the form n→s₁s₂ . . . sₖ, wherein n is a nonterminal, and each sᵢ is either a token or another nonterminal. SCFG is thus a context-free grammar with the addition of the P function.

Like any context-free grammar, the SCFG is said to generate (or accept) a given string (sequence of tokens) if the string can be produced starting from a sequence containing just the starting symbol S, and one by one expanding nonterminals in the sequence using the rules in the grammar. The particular way the string was generated can be naturally represented by a parse tree, with the starting symbol as the root, nonterminals as internal nodes, and the tokens as leaves.

The semantics of the probability function P are as follows: If r is the rule n→s₁s₂ . . . sₖ, then P(r) is the probability (i.e., the relative frequency) of expanding n using this rule. In other words, if it is known that a given sequence of tokens was generated by expanding n, then P(r) is the a priori likelihood that n was expanded using the rule r. Thus, it follows that for every nonterminal n, the sum ΣP(r) over all rules r headed by n must be equal to one.

In embodiments of the present invention, at least some of the nonterminal symbols of the SCFG correspond to meaningful language concepts, and the rules define the allowed syntactic relations between these concepts. When the grammar has been built, and the rules have been trained, the rules are used for parsing new sentences at step 46. In general, grammars are ambiguous, in the sense that a given string can be generated in multiple different ways. In non-stochastic grammars there is no way to compare different parse trees, so that the grammar can tell no more than whether a given sentence is grammatical, i.e., whether there is some parse that could produce it. Using the SCFG, different parses have different probabilities, and it is thus possible to resolve ambiguities by finding the likeliest parse.

In order to implement the present invention, it is not necessary to perform a full syntactic parsing of all sentences in the document. (Full parsing may actually be undesirable for performance reasons.) Instead, at steps 44 and 46, processor 24 performs only a very basic parsing to find relevant parts of the text. Within these parts, however, the grammar is much more detailed, and a full parse is performed. Examples of such grammars and parsing are presented hereinbelow.

In the classical definition of a SCFG, the rules are all assumed to be mutually independent. In actual applications of the present invention, however, the rules are often interdependent. Therefore, in some embodiments of the present invention, the probabilities P(r) may be conditioned upon the context in which the rule is applied. If the conditioning context is chosen judiciously, the well-known Viterbi algorithm (or a variant thereof) may be used to find the most probable parse tree for a sequence of tokens.

For example, in one embodiment of the present invention, the inventors used an agenda-based probabilistic chart parser, as described by Klein and Manning in a Stanford Technical Report, entitled “A O(n³) Agenda-Based Chart Parser for Arbitrary Probabilistic Context-Free Grammars,” Stanford Technical Report (Stanford University, 2001, available at dbpubs.stanford.edu/pub/2001-16), which is incorporated herein by reference. The inventors found that by implementing a simple approximation, the performance of the parser could be greatly enhanced without reducing the extraction accuracy. The approximation excludes a grammar edge from further consideration if its inner probability is less than a small fraction of the best probability currently achieved for the sequence spanned by the edge. The fraction value can be adjusted to trade accuracy for performance.

### SCFG Syntax and Examples

In embodiments, of the present invention, at step 42 (FIG. 2) the user creates a grammar comprising declarations and rules. Rules follow classical CFG syntax, with a special construction for assigning concept attributes as shown in the examples below. Notation shortcuts like “[ ]” and “I” can be used, respectively, to indicate inclusion of multiple elements and disjunction between elements in a rule. Nonterminal symbols referenced by the rules are declared before usage. Some nonterminal symbols can be declared as output concepts, which are the concepts (such as entities, events, and facts) that system 20 is intended to extract.

In addition, two novel classes of terminal symbols may be declared as part of the grammar:
A termlist is a collection of terms from a single semantic category, which may be either written explicitly or loaded from an external source. Examples of termlists include countries, cities, states, genes, proteins, people's first names, and job titles. Some linguistic concepts, such as lists of prepositions, can also be defined as termlists. Theoretically, a termlist is equivalent to a nonterminal symbol that has a rule for every term in the list.
An ngram is a construct that, when used in a rule, can expand to any single token. The probability of generating a given token, however, is not fixed in the rules, but is rather learned from the training dataset. This probability may be conditioned upon one or more previous tokens, thus permitting rules using ngrams to be context-dependent. In other words, the probability of generating a given token depends on the ngram, on the token, and on the immediate preceding context of the token. The semantics of ngrams are shown further in the examples that follow.

Table I below shows a simple, but meaningful, example of a grammar for use in the corporate acquisition domain:

TABLE I
SAMPLE GRAMMAR

```
output concept Acquisition(Acquirer, Acquired);
ngram AdjunctWord;
nonterminal Adjunct;
Adjunct:- AdjunctWord Adjunct|AdjunctWord;
termlist AcquireTerm = acquired bought (has
        acquired) (has bought);
Acquisition:- Company→Acquirer [“,” Adjunct “,”]
      AcquireTerm
      Company→Acquired;
```

The first line in Table I defines a target relation Acquisition, which has two attributes, Acquirer and Acquired. Then an ngram AdjunctWord is defined, followed by a nonterminal Adjunct, which has two rules, separated by “I”, together defining Adjunct as a sequence of one or more AdjunctWords. Next, a termlist AcquireTerm is defined, containing the main acquisition verb phrase. Finally, the single rule (indicated by the “:−” sign) for the Acquisition concept is defined as a Company followed by an optional Adjunct delimited by commas, followed by AcquireTerm and a second Company. The first Company is the Acquirer attribute of the output concept, and the second is the Acquired attribute.

The Acquisition rule requires the existence of a defined Company concept. This concept may be defined as follows:

TABLE II
DEFINITION OF COMPANY CONCEPT

```
output concept Company ( );
ngram CompanyFirstWord;
ngram CompanyWord;
ngram CompanyLastWord;
nonterminal CompanyNext;
Company:- CompanyFirstWord CompanyNext|
          CompanyFirstWord;
CompanyNext:- CompanyWord CompanyNext|
              CompanyLastWord;
```

Finally, the complete grammar needs a starting symbol and a special nonterminal None to match strings in parsed documents that do not belong to any of the declared concepts:

TABLE III
STARTING AND SPECIAL SYMBOLS

start Text;
nonterminal None;
ngram NoneWord;
None:- NoneWord None|;
Text:- None Text|Company Text|Acquisition Text;

The inventors have found that the brief code given above in Tables I-III is sufficient in order to enable system 20 to find many Acquisitions in knowledge base 22 (after training using corpus 32). The grammar itself is ambiguous, since an ngram can match any token, and thus Company, None, and Adjunct are able to match any string. The ambiguity is resolved, however, using the learned probabilities, so that processor 24 is usually able to find the correct interpretation.

### Training the SCFG

In the embodiment of the present invention that is described above, there are three different classes of trainable parameters in the SCFG:
Probabilities of rules relating to nonterminals;
Probabilities of different expansions of ngrams; and
Probabilities of terms in a termlist.
   All of these probabilities are calculated at step 44 as smoothed maximum likelihood estimates, based on the frequencies of the corresponding elements in the training dataset.

FIG. 3 is a flow chart that schematically shows details of training step 44, in accordance with an embodiment of the present invention. The method of training will be explained with reference to the following exemplary SCFG, which finds simple person names:

TABLE IV
SCFG FOR FINDING PERSON NAMES

```
  nonterm start Text;
  concept Person;
  ngram NGFirstName;
  ngram NGLastName;
  ngram NGNone;
  termlist TLHonorific = Mr Mrs Miss Ms Dr;
(1) Person:- TLHonorific NGLastName;
(2) Person:- NGFirstName NGLastName;
(3) Text:- NGNone Text;
(4) Text:- Person Text;
(5) Text:- ;
```

The numbers in parentheses at the left side of the rules in the table are not part of the rules and are used only for reference. The SCFG is trained, by way of example on the training set containing the sentence:
Yesterday, <Person>Dr Simmons</Person>, the distinguished scientist, presented the discovery.

To begin the training process, the documents in training corpus 32 are parsed using the untrained SCFG, subject to the constraints specified by the grammar, at a parsing step 50. Ambiguities, in which two or more parses are possible for a given token, may be resolved by calculating the relative probabilities of the symbols corresponding to the different parsing options. For example, in relation to the one-sentence training set given above, the constraints of the SCFG in Table IV are satisfied by two different parses, which expand Person by rules (1) and (2) respectively. The ambiguity arises because both TLHonorific and NGFirstName can generate the token “Dr”. (The SCFG does not know a priori that “Dr” is not a first name.) The ambiguity is resolved in favor of the TLHonorific interpretation, because the untrained SCFG gives:

```
P(Dr|TLHonorific) = 1/5 (choice of one term among five
  equiprobable terms in the termlist)
P(Dr|NGFirstName) ≈ 1/N (untrained ngram behavior,
  wherein N is the number of all known words)
```

After parsing the documents in the training corpus, processor 24 counts the frequencies of occurrence of the different elements of the grammar in the parsed documents, at a frequency counting step 52. By default, the initial untrained frequencies of all elements are set to 1, and are then updated at step 52. The result of training the SCFG of Table IV is shown below in Table V (wherein for the sake of compactness, only lines that were changed are shown). The frequencies are changed using the “<count>” syntax, as presented in the table:

TABLE V
TRAINED SCFG

termlist TLHonorific = Mr Mrs Miss Ms <2>Dr;
Person:- <2>TLHonorific NGLastName;
Text:- <11>NGNone Text;
Text:- <2>Person Text;
Text:- <2>;

The probabilities of the rules in the SCFG and of the individual elements in the termlists are then calculated directly from the count frequencies by smoothed maximum likelihood estimation, as is known in the art.

The training procedure also generates a file containing the statistics for the ngrams in the SCFG, at an ngram training step 54. The ngram statistics are more complex than those of the termlists and rules, because they take into account bigram frequencies, token feature frequencies and unknown words, as described below. Any ngram can generate any token, but the probability of generation depends on the ngram itself, on the generated token, and on the immediate preceding context of the token.

The term “feature,” as used in the context of the present patent application, refers to disjoint sets into which the tokens are partitioned. The frequencies of appearance of tokens belonging to different features may be used to improve the probability estimates of ngrams at step 54. Any suitable types of features may be used for this purpose. For example, token features may be defined by lexicographical properties, such as being Capitalized, ALLCAPS, numbers, punctuation tokens, etc. The CompanyFirstWord ngram defined above is much more likely to produce a Capitalized token than a lowercase word. As another example, token features may be defined in terms of parts-of-speech. Integrating the feature frequencies in the probability estimates improves the accuracy of ngram identification at step 46, especially when the evaluated documents contain new or rare words.

Since the specific tokens and token features are not part of the SCFG itself, any suitable tokenizer and/or token feature generator can be used by processor 24 at steps 44 and 46. (For example, an external Part-of-Speech tagger may be loaded from an external dynamic link library [DLL] specified in the SCFG.) It is even possible to use several feature generators simultaneously, so that different ngrams use different token feature sets. External tokenizers and feature generators may be useful for handling different languages, as well as for special domains. For instance, a feature set based on morphological features can be used to extract the names of chemical compounds or complex gene names. A part-of-speech (PoS) tagger may also be added as a feature generator, although the inventors have found that PoS tags are usually not necessary in embodiments of the present invention.

To calculate the ngram probabilities, the following statistics are collected at step 54:

```
Freq(*) = total number of times the ngram was encountered
    in the training set.
Freq(W), Freq(F), Freq(T) = number of times the ngram was
    matched to the word W, the feature F, and the token
    T, respectively. A token T is a pair consisting of
    a word W(T) and its feature F(T).
Freq(T|T₂) = number of times token T was matched to the
    ngram in the training set, when the preceding token
    was T₂.
Freq(*|T₂) = total number of times the ngram was
    encountered after the token T₂.
```

In addition, at step 54 processor 24 gathers statistics for use in processing unknown tokens. In parsing new documents at step 46, all tokens not encountered during training are considered to be the same “unknown” token and are then processed using the “unknown” token statistics determined at step 54. (The fact that a token was never encountered during training may in itself provide useful information as to the nature of the token.) In order to learn to correctly handle unknown tokens, an “unknown” model is trained at step 54 by dividing the training data into two partitions. All tokens in one partition that are not present in the other partition are treated as “unknown” tokens. The probability that a given ngram will generate the “unknown” token is then calculated from the “unknown” statistics. The model trained in this way is used whenever an unknown token, which was not encountered in training corpus 32, is encountered during document analysis.

After all the statistics are gathered, processor 24 calculates the probabilities for each ngram to generate each possible token, at an ngram probability computation step 56. The inventors have found that interpolation between the statistical frequencies determined at step 54 gives good results. For example, one possible formula for the estimated probability that an ngram will generate token T, given that the preceding token is T₂, is as follows:
P(T|T₂)=½·Freq(T|T₂)/Freq(*|T₂)++¼·Freq(T)/Freq(*)++¼·Freq(W)·Freq(F)/Freq(*)².
This formula linearly interpolates between three models: a bigram model in the first line of the formula, a backoff unigram model in the second line, and a further backoff word+feature unigram model in the third line. The interpolation factor of ½ was found to give good results, but accuracy of extraction at step 46 was not strongly influenced by changes in the interpolation factors.

Although the rule probabilities calculated at step 52 in the example above are independent of context, the rules become implicitly context-dependent due to the ngrams that they contain. Furthermore, the probabilities of the different rules that apply to a given nonterminal symbol may alternatively depend explicitly on their context. For example, the rules that apply to a specific nonterminal can be conditioned upon the previous token, like the ngram probabilities. More complex conditional schemes are also possible, such as using maximal entropy to combine several conditioning events.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A computer-implemented method for information extraction, comprising:
defining a stochastic context free grammar (SCFG) comprising symbols and rules applicable to the symbols, the symbols comprising at least one output concept;
training the SCFG on a tagged training corpus so as to determine probabilities of the rules and of one or more of the symbols; and
parsing a document using the rules and symbols responsively to the probabilities so as to extract occurrences of the at least one output concept from the document.

2. The method according to claim 1, wherein the symbols in the SCFG comprise a termlist symbol, which comprises a collection of terms from a single semantic category.

3. The method according to claim 1, wherein the symbols in the SCFG comprise an ngram symbol, such that when the ngram symbol is used in one of the rules, it can expand to any single token.

4. The method according to claim 3, wherein training the SCFG comprises computing the probabilities of different expansions of the ngram symbol.

5. The method according to claim 4, wherein computing the probabilities comprises finding conditional probabilities of the different expansions depending upon a context of the ngram symbol.

6. The method according to claim 5, wherein computing the probabilities comprises interpolating over a bigram probability model depending upon the context of the ngram symbol and a unigram probability model of the ngram symbol.

7. The method according to claim 3, wherein the ngram symbol comprises an unknown symbol, and wherein parsing the document comprises applying the probabilities determined with respect to the unknown symbol in parsing an unknown token in the document.

8. The method according to claim 1, wherein defining the SCFG comprises defining a dependence of at least one of the rules on a context of a symbol to which the at least one of the rules is to apply, and wherein training the SCFG comprises finding a conditional probability of the at least one of the rules depending upon the context of the symbol.

9. The method according to claim 1, wherein parsing the document comprises applying an external feature generator in order to identify features of tokens in the document, and extracting the occurrences of the at least one output concept responsively to the features.

10. The method according to claim 1, and comprising, after parsing the document, enhancing the SCFG by performing at least one of adding a further rule to the SCFG and further tagged tokens to the training corpus.

11. A computer software product, comprising a computer-readable medium in which program instructions are stored, which instructions, when read by a computer, cause the computer to receive a definition of a stochastic context free grammar (SCFG) comprising symbols and rules applicable to the symbols, the symbols comprising at least one output concept, to train the SCFG on a tagged training corpus so as to determine probabilities of the rules and of one or more of the symbols, and to parse a document using the rules and symbols responsively to the probabilities so as to extract occurrences of the at least one output concept from the document.

12. The product according to claim 11, wherein the symbols in the SCFG comprise a termlist symbol, which comprises a collection of terms from a single semantic category.

13. The product according to claim 11, wherein the symbols in the SCFG comprise an ngram symbol, such that when the ngram symbol is used in one of the rules, it can expand to any single token.

14. The product according to claim 13, wherein the instructions cause the computer to compute the probabilities of different expansions of the ngram symbol.

15. The product according to claim 14, wherein the probabilities of the different expansions comprise conditional probabilities depending upon a context of the ngram symbol.

16. The product according to claim 15, wherein the instructions cause the computer to compute the probabilities by interpolating over a bigram probability model depending upon the context of the ngram symbol and a unigram probability model of the ngram symbol.

17. The product according to claim 13, wherein the ngram symbol comprises an unknown symbol, and wherein the instructions cause the computer to apply the probabilities determined with respect to the unknown symbol in parsing an unknown token in the document.

18. The product according to claim 11, wherein the SCFG defines a dependence of at least one of the rules on a context of a symbol to which the at least one of the rules is to apply, and wherein the instructions cause the computer to find a conditional probability of the at least one of the rules depending upon the context of the symbol.

19. The product according to claim 11, wherein the instructions cause the computer to apply an external feature generator in order to identify features of tokens in the document, and to extract the occurrences of the at least one output concept responsively to the features.

20. The product according to claim 11, wherein the product causes the computer, after parsing the document, to enable a user to enhance the SCFG by performing at least one of adding a further rule to the SCFG and further tagged tokens to the training corpus.

21. Apparatus for information extraction (IE), comprising:
an input interface, which is coupled to receive a definition of a stochastic context free grammar (SCFG) comprising symbols and rules applicable to the symbols, the symbols comprising at least one output concept; and
an IE processor, which is adapted to train the SCFG on a tagged training corpus so as to determine probabilities of the rules and of one or more of the symbols, and to parse a document using the rules and symbols responsively to the probabilities so as to extract occurrences of the at least one output concept from the document.

22. The apparatus according to claim 21, wherein the symbols in the SCFG comprise a termlist symbol, which comprises a collection of terms from a single semantic category.

23. The apparatus according to claim 21, wherein the symbols in the SCFG comprise an ngram symbol, such that when the ngram symbol is used in one of the rules, it can expand to any single token.

24. The apparatus according to claim 21, wherein the SCFG defines a dependence of at least one of the rules on a context of a symbol to which the at least one of the rules is to apply, and wherein the processor is adapted to find a conditional probability of the at least one of the rules depending upon the context of the symbol.
